(19) United States
(12) Patent Application Publication
(10) Pub. No.: US 2003/0205331 A1
(43) Pub. Date: Nov. 6, 2003

(54) Sticky memo roll

(75) Inventor: David Jour, Taipei (TW)

Correspondence Address: BACON & THOMAS, PLLC, 625 SLATERS LANE, FOURTH FLOOR, ALEXANDRIA, VA, 22314

(73) Assignee: Kudos Finder Trading Co., Ltd., Taipei (TW)

(21) Appl. No.: 10/138,645

(22) Filed: May 6, 2002

(51) Int. Cl. B32B 31/00

(52) U.S. Cl. 156/577

(57) ABSTRACT

Sticky memo roll includes multi color memo sticker roll and self-cutting memo-fed. The memo sticker roll is made by water-fast material and recordable surface for letters and symbols. The self-cutting memo-fed is assembled by two side-holders, indent blade and blade stand. Two side-holders contain side notch space to stabilize multi color sticker roll. On the application, user is allowed to chose from different color memo sticker as necessary and cut in different length upon usage, hence offering a convenient, effective and efficient multi function.

### BACKGROUND OF THE INVENTION

The present invention is related to a sticky memo roll, in particular the sticky memo roll contain multiple color sticky memo and memo-fed embed with safety blade. Allowing user to chose from different color memo sticker as necessary and cut in different length upon usage, hence offering an effective and efficient multi function.

A conventional memo allows convenience of wring and recording notes, as these memo sold on the market in the early time are for general public convenient usage. Most of these memos are in different type, size and length upon user's needs. These memo have to be consumed in one complete sheet upon each usage hence a waste. Cutting of the blank space on the same sheet is a time consume work, and tear by hand will not be present hence not effective. Sometimes, user found such single memo sheet size is not sufficient as large amount of letters or symbols need to be recorded second or more sheet are required, and such memo need to be stabilized by pins or alike which is easy to get lost or leave behind hence not convenient. For the above mentions, they have become the defects of the conventional memo. Some people is then come up with an improved memo sheet, which contain small amount of glue on the surface of particular area and layering all memo sheet in a pile. Despite this solve the problem of sticking memo of application, user would still have to get different size memo sheet upon usage hence not an economic and effective way.

The present invention can be best understood through the following description and accompanying drawings wherein:

### BRIEF DESCRIPTION OF THE DRAWINGS

FIG. 1 is an embodiment of the present invention;

FIG. 2 is an assembled view of the present invention;

FIG. 3 shows the application of the present invention;

FIG. 4 shows the structured view of the present invention;

### DETAILED DESCRIPTION OF THE PREFERRED EMBODIMENTS

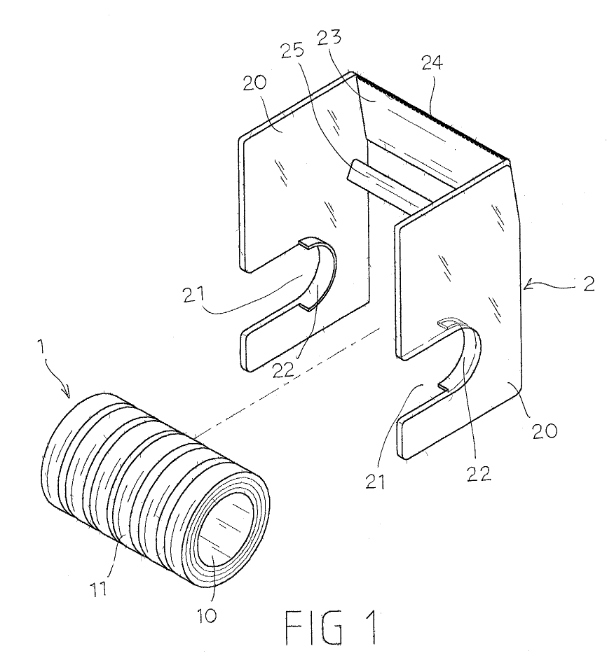

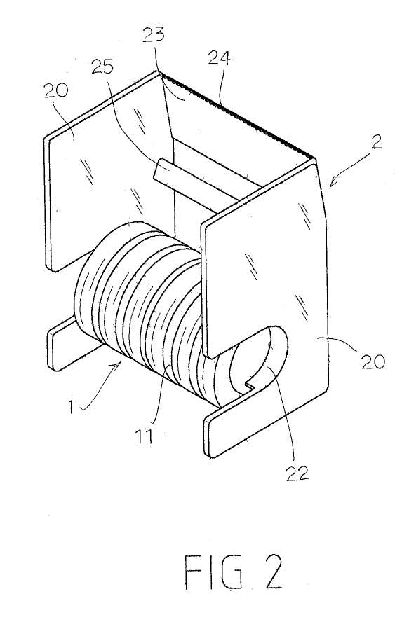

Please refer to FIGS. 1 and 2; the present invention-sticky memo roll includes multi color memo sticker roll (1) and self-cutting memo-fed (2). Wherein the memo sticker roll (1) contain a roll-fed (10) and multi color sticky memo (11). All type of sticky memo are made from water-fast material with glue on one side, and special processed smooth surface on the other side allowing recording of letters and symbols.

The memo-fed (2) contain two side holders (20) and a notch space (21) on each holder (20) to form the stabler (22) allow fitting of reel-fed (10). Two side holder (20) connected to blade stand (23), and the blade (24) is embedding in front on the blade stand (23) allowing cutting of sticky memo (11). The batten (25) is situated beside the blade stand (23) to stable the sticky memo (11) when the pulling the memo, the blade stand (23) is in bevel position concerning safety usage.

### SUMMARY OF THE INVENTION

It is therefore a primary objective of the present invention to provide a sticky memo roll. User allow to chose from different color memo sheet upon usage, and cutting the appropriate length of memo sheet as necessary to eliminate waste usage hence allowing a convenient, effective and efficient cutting and sticking when using such memo.

The present sticky memo roll includes multi color memo sticker roll and self-cutting memo-fed. The roll is fitted on the memo fed allow convenience of rolling the memo sheet, and the indent blade allow instant cutting of the appropriate length of memo sheet as necessary.

Please refer to FIGS. 1 and 2; the present invention-sticky memo roll includes multi color memo sticker roll (1) and self-cutting memo-fed (2). Wherein the memo sticker roll (1) contain a roll-fed (10) and multi color sticky memo (11). All type of sticky memo are made from water-fast material with glue on one side, and special processed smooth surface on the other side allowing recording of letters and symbols.

The memo-fed (2) contain two side holders (20) and a notch space (21) on each holder (20) to form the stabler (22) allow fitting of reel-fed (10). Two side holder (20) connected to blade stand (23), and the blade (24) is embedding in front on the blade stand (23) allowing cutting of sticky memo (11). The batten (25) is situated beside the blade stand (23) to stable the sticky memo (11) when the pulling the memo, the blade stand (23) is in bevel position concerning safety usage.

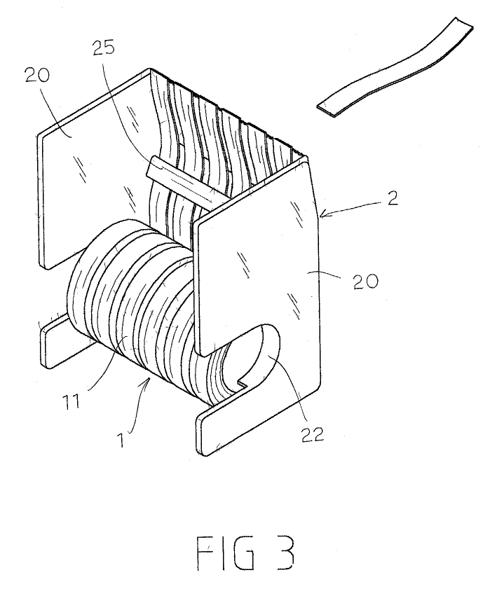

FIG. 3 shows the application of present invention, user allow to cut the appropriate length of memo sheet as necessary by simply pulling the sticky memo (11) towards the blade (24), different color of sticky memo (11) allowed classification upon personal preference. When present sticky memo (11) is using for recording letters, the appropriate length of sticky memo (11) can be cut by pulling the memo sheet towards the blade (24).

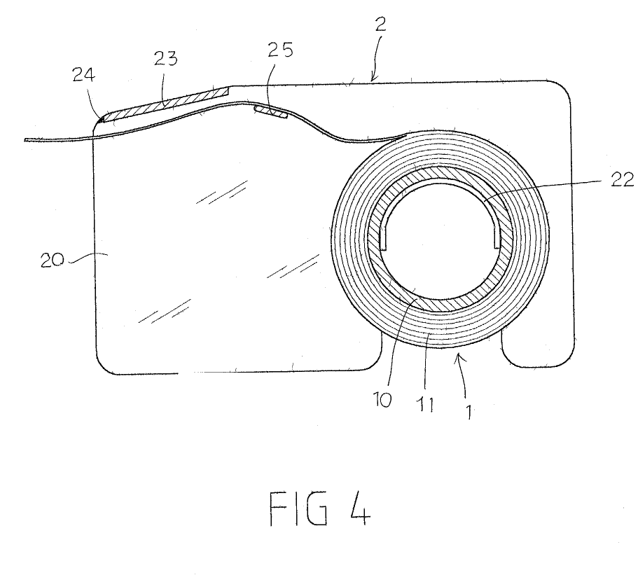

The structure of memo-fed (2) is only contain two side holder (20), which allowed an easy procedure of disassemble when changing sticky memo (11). The reel-fed (10) can be taken off by pulling the two side holder (20) when changing the sticky memo (11), new sticky memo (11) can be loaded onto the reel-fed (10) in between the two side holder (20) by reverse the above procedure. The stabler (22) holds the reel-fed (10) allowing rolling effect. The sticky memo (11) is then pulling out through the batten (25) towards the blade (24) to get cutting off in any length. Please refer to FIG. 4 to get the assembled and disassembled view of present invention.

In addition, the sticky memo (11) is made from the water-fast material that allows long storage. One side surface of the sticky memo is made through special process which allow a clear records of letters and symbols, and the other side of surface is covered by glue allow antiskid.

What is claimed is:

1 A sticky memo roll includes multi color memo sticker roll and self-cutting memo-fed. The sticker roll contain multiple sticky memo color, whereas the self-cutting memo-fed is assembled by two side-holders which contain side notch space to stabilize multi color sticker roll. The two side-holders are bond by blade stand with blade embed in front to allow cutting of sticky memo, and a batten beside the blade.

2 A sticky memo roll as claimed in claim 1, wherein the memo sticker roll is made by water-fast material with glue on one side, and special processed smooth surface on the other side allowing recording of letters and symbols.

3 A sticky memo roll as claimed in claim 1, wherein the blade stand is in bevel position concerning safety usage.
